(19) United States
(12) Patent Application Publication
(10) Pub. No.: US 2007/0150871 A1
(43) Pub. Date: Jun. 28, 2007

(54) Autonomically adjusting the collection of performance data from a call stack

(75) Inventors: Eric Lawrence Barsness, Pine Island, MN (US); Daniel E. Beuch, Rochester, MN (US); Richard Allen Saltness, Rochester, MN (US); John Matthew Santosuosso, Rochester, MN (US)

Correspondence Address: WOOD, HERRON & EVANS, L.L.P. (IBM), 2700 CAREW TOWER, 441 VINE STREET, CINCINNATI, OH, 45202, US

(73) Assignee: INTERNATIONAL BUSINESS MACHINES CORPORATION, ARMONK, NY (US)

(21) Appl. No.: 11/316,287

(22) Filed: Dec. 22, 2005

(51) Int. Cl. G06F 9/44

(52) U.S. Cl. 717/128

(57) ABSTRACT

A program product, an apparatus, and method of autonomically adjusting when performance data from a call stack is collected during a trace. In particular, the sampling interval between call stack collections may be autonomically adjusted while a trace is executing based upon the call stack, various performance metrics, and/or previous call stack collections.

### FIELD OF THE INVENTION

The invention relates to collecting performance data, and in particular, collecting performance data from a call stack.

### BACKGROUND OF THE INVENTION

Performance data is oftentimes collected for a computer program or system to assist developers or system administrators in improving the performance of the computer program or system. For example, performance data may assist in the identification of errors in the underlying code of a computer program, unnecessary instructions in a computer program, or other aspects such as inefficient use of CPU and/or I/O resources, etc.

To identify potential sources of performance problems, a computer program is often traced. A trace is a record of the execution of a computer program. Tracing a computer program may be implemented by recording the state of the computer program at frequent intervals during the execution of the computer program. By tracing the computer program, performance related data in the record of the computer program's execution may be gathered and sources of problems may often be identified through analysis of the state of the program when an error occurs.

However, collecting performance data can be a daunting task in the sense that a fully traced system usually provides too much data. For example, a computer program may reference many methods, objects, etc. and gathering performance information about each may result in the collection of too much performance data. Generally, the problem is twofold because a fully traced system burdens the system with too much of a load in collecting the data, and the amount of data collected becomes too cumbersome to manage.

As a result, developers often rely on a more limited form of trace known as a stack trace, where the state of a the call stack of a computer program is periodically collected, rather than fully tracing a program. A call stack is a data structure that keeps track of the sequence of routines or functions called in a computer program. Typically, a call stack may contain a variety of data, e.g., a name of a function or routine that was called by the program, an indication of the order in which functions were called by the program, local variables, call parameters, return parameters, etc. Any of this performance data may be collected in connection with collecting the call stack. Furthermore, other performance data associated with the call stack and/or executing computer program such as, but limited to, CPU and 1/O utilization, may also be collected.

Usually, a call stack is based upon a last in first out algorithm (LIFO) where the last data placed or pushed on the stack, is the first one removed or popped from the stack. As an example, in a computer program A where a function 1 executes and calls function 2, the name of function 1 is pushed on the stack when it is called and then the name of function 2 is pushed on the stack when called by function 1, along with any arguments being passed to function 2 by function 1. When processing of function 2 completes, the name of function 2 is typically popped off the stack along with any return data. Finally, when function 1 completes, the name of function 1 is likewise popped off the stack. Thus, as an example, the source of an error is often capable of being identified by looking at the call stack to determine which function was called and/or the values of the variables passed between the functions when the error occurred.

Generally, any of this performance data associated with the call stack, i.e., performance data from the call stack, CPU and I/O utilization, etc., may be collected by dumping or collecting call stack data. Once collected, the data may be stored on a storage device, printed, etc.

The collected performance data may be used by developers to identify patterns and/or try to determine missed events from the periodic call stack collections. Thus, developers may rely on the collected data for a big picture view of the events of a computer program as opposed to fully tracing computer program. For instance, by periodically collecting the call stack, a developer may, within reason, create output that looks very similar to what would have resulted if every method of the computer program was hooked, i.e. traced. Although developers may have to make certain assumptions about the missed events of the computer program based upon the collected performance data, developers may successfully determine invocation counts, re-construct call stacks, assign performance counters to methods on and off the stack, etc.

However, even with this latter approach, periodically collecting the call stack may also be problematic. In particular, the amount of data collected may also become burdensome for the system, and further, require a developer to sort through large volumes of data, if the interval used to collect the call stack is too frequent. Conversely, collecting too little performance data by increasing the interval between call stack collections, e.g., to avoid burdening the system, may result in many missed events. Thus, developers may not be able to even make reasonable assumptions about the missed events because too little performance data was collected. In particular, this latter approach generally requires more manual work by developers than is desired. For instance, developers may have to manually determine when the call stack should be periodically collected in light of the problems associated with collecting too much performance data and/or too little performance data. Moreover, developers may have to manually adjust the sampling interval, i.e., the time period between successive collections of the call stack.

A need therefore exists in the art for an improved approach of collecting performance data, and in particular, an improved approach for collecting performance data from a call stack that is not as burdensome to the user or the system.

### SUMMARY OF THE INVENTION

The invention addresses these and other problems associated with the prior art by providing an apparatus, program product and method that autonomically adjust when performance data from a call stack is collected during a trace. Typically, the autonomic adjustments may facilitate the collection of performance data in a manner that reduces the burden on users and/or the system by collecting the call stack more frequently or less frequently as appropriate.

For example, certain embodiments consistent with the invention may autonomically adjust when the performance data from a call stack is collected based upon preset algorithms associated with a performance metric, the call stack and/or the results of previous collections of one call stack. In particular, the adjustment may be made by adjusting the sampling interval, e.g., increasing the sampling interval between collections of the call stack or decreasing the interval between collections of the call stack.

These and other advantages and features, which characterize the invention, are set forth in the claims annexed hereto and forming a further part hereof. However, for a better understanding of the invention, and of the advantages and objectives attained through its use, reference should be made to the Drawings, and to the accompanying descriptive matter, in which there is described exemplary embodiments of the invention.

### BRIEF DESCRIPTION OF THE DRAWINGS

FIG. 1 is a block diagram of a networked computer system including an operating system within which is implemented collection of performance data consistent with the invention.

FIG. 2 is a flowchart illustrating the program flow of one implementation of a program tracing routine.

FIG. 3 is a flowchart illustrating the program flow of one implementation of a rule processing routine utilized by the routine in FIG. 2.

FIG. 4 is a flowchart illustrating the program flow of one implementation of a metric adjusting routine utilized by the routine in FIG. 2.

FIG. 5 is a flowchart illustrating the program flow of one implementation of a metric monitoring routine.

### DETAILED DESCRIPTION

The embodiments discussed hereinafter autonomically adjust when performance data from a call stack is collected (i.e., copied) during a trace. Performance data consistent with the invention may be practically any data and/or metric associated with performance. It is worth noting that the terms performance data and performance metric are used interchangeably herein and their interchangeable use is not intended to limit the scope of the invention as will be appreciated by those of ordinary skill in the art. Examples of performance data may be, but are not limited to, memory pool size, drive utilization, I/O utilization, CPU utilization, etc. Furthermore, practically any data capable of being maintained in a call stack may be considered performance data within the context of the invention.

A call stack may be practically any data structure that includes information used to track the functions or routines currently being executed by a computer program. A call stack may contain a variety of data, e.g., local variables, call parameters, return parameters, names of functions or routines that were called by a program, an indication of the order in which functions were called by the program, etc. Generally, call stacks are utilized to debug a program and identify errors, for example, by looking at the order of the functions one may see the last function called before an error and the function that called the last function, which may indicate that the error is associated with those two functions. Nonetheless, any data on the call stack, i.e., pushed on the call stack, and/or any data removed from the call stack, i.e., popped off the call stack, may be considered performance data consistent with the invention.

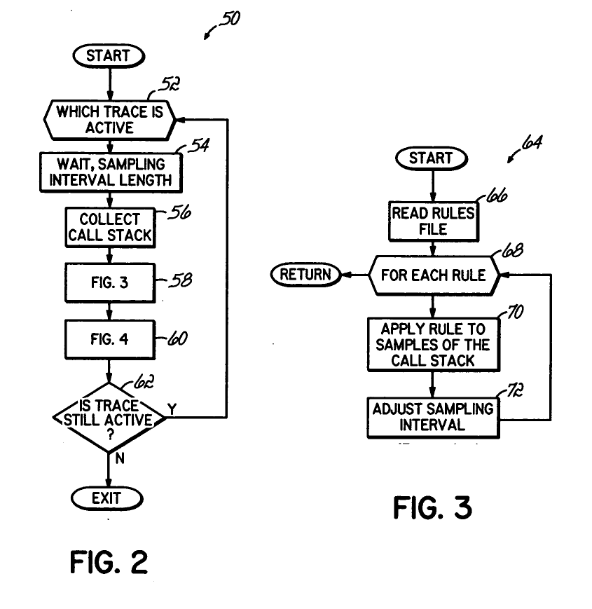

Consistent with the invention, autonomically adjusting when performance data from a call stack is collected during a trace may depend upon a variety of considerations. Autonomically adjusting when performance data from a call stack is collected generally refers to a self-managed capability to adjust when performance data from a call stack is collected with minimal human interference. In particular, the adjustment may depend upon a performance metric, e.g., CPU utilization, and/or the adjustment may depend upon the call stack, e.g., certain packages, classes, etc. that are referenced in the call stack. Furthermore, the adjustment may depend on previous collections of the call stack, e.g., from a comparison of previous collections of the call stack to the current call stack, and/or the adjustment may depend upon a performance metric and/or data collected from previous collections. On the other hand, adjustments may depend on the current call stack and/or current performance metrics. As an example, if the current call stack is compared to previous collections of the call stack and a significant change is indicated, the collection of the next call stack may be autonomically adjusted to occur sooner and/or more frequently, generally resulting in the collection of more performance data associated with the change. Furthermore, those of ordinary skill in the art may appreciate that autonomically adjusting when performance data is collected may generally be based upon whether skipped events may be reconstructed. These and additional considerations will be discussed in greater detail hereinafter in connection with FIGS. 2-5.

As a practical matter, the autonomic adjustment may be accomplished by adjusting the sampling interval associated with the collection of the call stack. Generally, a sampling interval consistent with the invention may be practically any period of time between successive collections of the call stack. In general, a shorter interval will result in the collection of more performance data, while a longer interval will result in the collection of less data.

It is worth noting that the terms collecting the performance data from the call stack and collecting the call stack are used interchangeably herein and their interchangeable use is not intended to limit the scope of the invention, as will be appreciated by those of ordinary skill in the art.

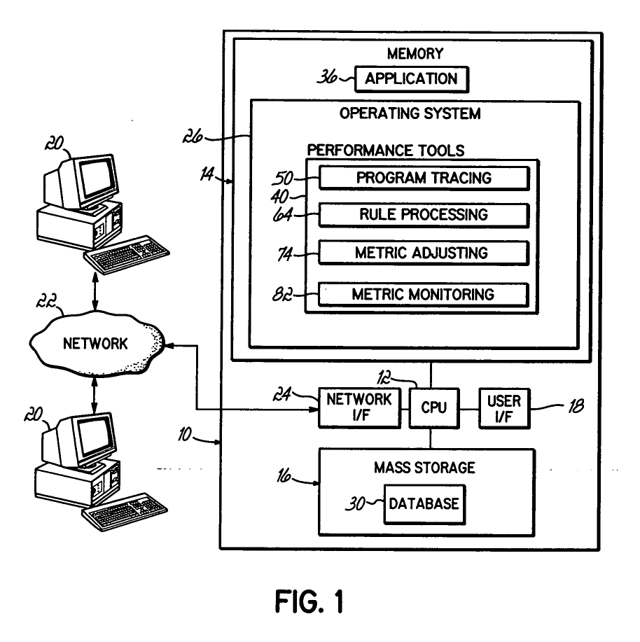

Turning now to the Drawings, wherein like numbers denote like parts throughout the several views, FIG. 1 illustrates an exemplary hardware and software environment for an apparatus 10 consistent with the invention. For the purposes of the invention, apparatus 10 may represent practically any type of computer, computer system or other programmable electronic device, including a client computer, a server computer, a portable computer, a handheld computer, an embedded controller, etc. Moreover, apparatus 10 may be implemented using one or more networked computers, e.g., in a cluster or other distributed computing system. Apparatus 10 will hereinafter also be referred to as a “computer,” although it should be appreciated that the term “apparatus” may also include other suitable programmable electronic devices consistent with the invention.

Computer 10 typically includes a central processing unit (CPU) 12 including one or more microprocessors coupled to a memory 14, which may represent the random access memory (RAM) devices comprising the main storage of computer 10, as well as any supplemental levels of memory, e.g., cache memories, non-volatile or backup memories (e.g., programmable or flash memories), read-only memories, etc. In addition, memory 14 may be considered to include memory storage physically located elsewhere in computer 10, e.g., any cache memory in a processor in CPU 12, as well as any storage capacity used as a virtual memory, e.g., as stored on a mass storage device 16 or on another computer coupled to computer 10.

Computer 10 also typically receives a number of inputs and outputs for communicating information externally. For interface with a user or operator, computer 10 typically includes a user interface 18 incorporating one or more user input devices (e.g., a keyboard, a mouse, a trackball, a joystick, a touchpad, and/or a microphone, among others) and a display (e.g., a CRT monitor, an LCD display panel, and/or a speaker, among others). Otherwise, user input may be received via another computer or terminal, e.g., via a client or single-user computer 20 coupled to computer 10 over a network 22. This latter implementation may be desirable where computer 10 is implemented as a server or other form of multi-user computer. However, it should be appreciated that computer 10 may also be implemented as a standalone workstation, desktop, or other single-user computer in some embodiments.

For non-volatile storage, computer 10 typically includes one or more mass storage devices 16, e.g., a floppy or other removable disk drive, a hard disk drive, a direct access storage device (DASD), an optical drive (e.g., a CD drive, a DVD drive, etc.), and/or a tape drive, among others. Furthermore, computer 10 may also include an interface 24 with one or more networks 22 (e.g., a LAN, a WAN, a wireless network, and/or the Internet, among others) to permit the communication of information with other computers and electronic devices. It should be appreciated that computer 10 typically includes suitable analog and/or digital interfaces between CPU 12 and each of components 14, 16, 18, and 24 as is well known in the art.

Computer 10 operates under the control of an operating system 26, and executes or otherwise relies upon various computer software applications, components, programs, objects, modules, data structures, etc. Additionally, various applications, components, programs, object, modules, etc. may also execute on one or more processors in another computer coupled to computer 10 via a network, e.g., in a distributed or client-server computing environment, whereby the processing required to implement the functions of a computer program may be allocated to multiple computers over a network.

In particular, an application 36 may be resident in memory 14 and used to access a database 30 resident in mass storage 16. Database 30 may also be accessible by the operating system 26. Additionally, performance tools 40 may be accessible by operating system 26. Generally, performance tools 40 may incorporate four routines, a program tracing routine 50, a rule processing routine 64, an metric adjusting routine 74, and a metric monitoring routine 82.

A trace may be preformed on practically any code, program, application, etc. The term “program” is used for simplicity and should not limit the scope of the invention. Generally, while tracing a program with the tracing routine 50, the rule processing routine 64 and the metric adjusting routine 74 may be utilized to autonomically adjust when performance data from a call stack of the program is collected. The metric monitoring routine 82 may be a standalone routine which generally monitors performance metrics of a program and autonomically adjusts when the call stack of the program should be collected based upon the performance metrics. The autonomic adjustments may be accomplished by adjusting the sampling interval between collections of the call stack.

In general, the routines executed to implement the embodiments of the invention, whether implemented as part of an operating system or a specific application, component, program, object, module or sequence of instructions, or even a subset thereof, will be referred to herein as “computer program code,” or simply “program code.” Program code typically comprises one or more instructions that are resident at various times in various memory and storage devices in a computer, and that, when read and executed by one or more processors in a computer, cause that computer to perform the steps necessary to execute steps or elements embodying the various aspects of the invention. Moreover, while the invention has and hereinafter will be described in the context of fully functioning computers and computer systems, those skilled in the art will appreciate that the various embodiments of the invention are capable of being distributed as a program product in a variety of forms, and that the invention applies equally regardless of the particular type of computer readable media used to actually carry out the distribution. Examples of computer readable media include but are not limited to tangible, recordable type media such as volatile and non-volatile memory devices, floppy and other removable disks, hard disk drives, magnetic tape, optical disks (e.g., CD-ROMs, DVDs, etc.), among others, and transmission type media such as digital and analog communication links.

In addition, various program code described hereinafter may be identified based upon the application within which it is implemented in a specific embodiment of the invention. However, it should be appreciated that any particular program nomenclature that follows is used merely for convenience, and thus the invention should not be limited to use solely in any specific application identified and/or implied by such nomenclature. Furthermore, given the typically endless number of manners in which computer programs may be organized into routines, procedures, methods, modules, objects, and the like, as well as the various manners in which program functionality may be allocated among various software layers that are resident within a typical computer (e.g., operating systems, libraries, API's, applications, applets, etc.), it should be appreciated that the invention is not limited to the specific organization and allocation of program functionality described herein.

Those skilled in the art will recognize that the exemplary environment illustrated in FIG. 1 is not intended to limit the present invention. Indeed, those skilled in the art will recognize that other alternative hardware and/or software environments may be used without departing from the scope of the invention.

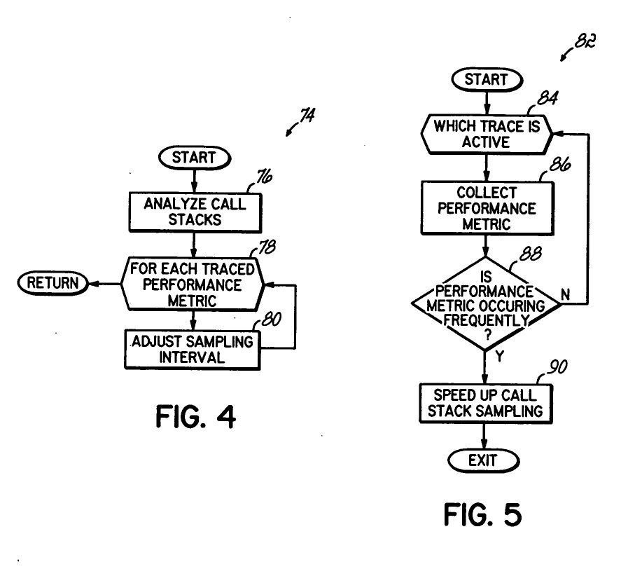

Turning now to FIGS. 2-5, in particular, FIG. 2 and FIG. 5 illustrate exemplary routines suitable for use in autonomically adjusting when performance data from a call stack is collected in a manner consistent with the invention. In particular routine 50 in FIG. 2 and routine 60 in FIG. 5 are implemented while a trace is executing. Generally, a trace may be executed for any program (including portions of the operating system). The routines illustrated in FIGS. 3 and 4 may be called by the routine in FIG. 2.

Turning to FIG. 2, the first block of routine 50 determines which trace is active. In particular, more than one program may be traced on a system. Thus, block 52 determines if the proper trace for which to process the remainder of routine 50 is active. The trace may be determined using any conventional technique.

Next, control passes to block 54 to wait for the length of the sampling interval. Initially, the value of the sampling interval may be set by a user, by the system, and/or any other conventional technique. Additionally, the sampling interval may have been set during a previous iteration of routine 50. However, it is worth noting that the sampling interval may be adjusted during the iterations of the loop defined by blocks 52-62. Nonetheless, after waiting the length of the sampling interval, the call stack is collected in block 56. A user and/or a system may specify where the performance data is collected to using conventional techniques.

Next control passes to block 58, which calls routine 64 in FIG. 3. Briefly, in routine 64, rules may be applied to the current call stack and/or previously sampled call stacks, and if the conditions of any of the rules are satisfied, the sampling interval may be adjusted. Once routine 64 completes, control returns to block 58 in FIG. 2. Next, control may pass to block 60. Block 60 calls routine 74 in FIG. 4, where the sampling interval may be adjusted depending on a performance metric and/or previously collected performance data, e.g., CPU utilization, I/O utilization, etc. Once routine 74 completes, control returns to block 60 in FIG. 2. Therefore, the interval at which the call stack may be collected may be adjusted by either of routine 64 and/or routine 74. Generally, the adjustment may be based upon a call stack in routine 64, whereas the adjustment may be based upon a specific metric in routine 74. Routine 64 in FIG. 3 and routine 74 in FIG. 4 will be discussed hereinafter.

Returning to block 60 in FIG. 2, control next passes to block 62. Block 62 determines if the trace is still active. If not, routine 50 exits. On the other hand, if the trace is still active, then control passes to block 52 to determine which trace is active. If the trace for which the adjustment was conducted in block 58 and/or 60 is the active trace, then the remaining blocks of the loop may be processed. In particular, with respect to block 54, one of ordinary skill in the art may appreciate that the sampling interval may have changed since the last collection because it may have been autonomically adjusted during the previous iteration of routine 50 by the routine in FIG. 3 and/or the routine in FIG. 4.

Turning to FIG. 3, routine 64 is used to adjust a sampling interval based upon the state of the call stack. Routine 64 begins in block 66 by reading a rules file. For example, a XML based rules file may be used. Generally, a rules file may outline the rules that determine when to autonomically adjust the collection of the call stack; thus, speeding up or slowing down the collection of performance data. In particular, the goals of the user and/or system may be reflected in the rules. For example, if a developer is concerned with a particular package or class on the stack and how it changes, the developer may want to collect the call stack more frequently during the periods when the package or class changes.

Generally, a rule may be practically any condition that may implemented in connection with performance. For example, in a first type of rule, autonomically adjusting the collection of the call stack may be based upon at least one change between at least one previously sampled call stack and the current call stack. For instance, a previously collected call stack may be compared to the current call stack, or vice versa, in their entireties and/or less than their entireties for changes. With respect to the latter, the two samples may be mostly identical, except, for example, the bottom ten spots consisting of JDK methods and/or system level call stacks handling database work. The difference may or may not be significant, thus, the rule may also indicate that changes that are not statistically different should be ignored. Similarly, the rule may even specify the requisite change.

Furthermore, in a second type of rule, autonomically adjusting the collection of the call stack may be based upon information collected from previous collections of performance data. The information collected may be the actual performance data, inferences, knowledge gained from the previous collections of performance data, etc. For example, assuming that in a past pair of collections, the call stack changed significantly based on the then-used interval, therefore, in that first pass, a lot of performance data was not collected. Thus, a developer and/or system may learn that a lot of performance data was not collected and a lot of events were missed, and may use the information to determine that the next time a call stack matching the first one of that pair occurs, the autonomic adjustments may be made. As a result, next time a call stack matching the first one occurs, the collection of the call stack matching the first may be sped up, i.e., the sampling interval decreased, to gather more performance data. Similarly, information collected from previous collections of performance data may be used to increase the sampling interval; thus, collecting less performance data.

Additionally, in a third type of rule, an autonomic adjustment may be made based upon what is executing on a call stack. For example, a rule may indicate that when there is change in a certain class, package, method, procedure, routine, inlined program code, etc. a user and/or system is interested in, the collection may be sped up or slowed down. With this third type of rule, the current call stack and a previous call stack may be compared for a change to at least one class or package. The class or package may be predetermined by a user and/or system. Additionally, any conventional technique known to those of ordinary skill in the art may be used to designate the class or package.

Another type of rule may indicate that when a certain pattern appears in a call stack, an autonomic adjustment should be made. The pattern may be predetermined by a user and/or system. Additionally, any conventional technique known to those of ordinary skill in the art may be used to designate a pattern to be identified and/or determine how to identify the pattern from the stack. For example, when abc is followed by xyz, an autonomic adjustment may be performed. Furthermore, those of ordinary skill in the art may appreciate that the call stack may analyzed during the trace for the pattern; and the autonomic adjustment is based upon this analysis, e.g., the autonomic adjustment is made when the pattern is detected. Thus, the interval may be changed based upon the analysis of the call stack and detection of the pattern, and the call stack may be collected according to the new interval in routine 50 in FIG. 2. Those of ordinary skill in the art may appreciate that other instances of analyzing the call stack during a trace and autonomically adjusting when performance data is collected based upon the analysis may be identified in the embodiments discussed herein.

Another type of rule may indicate that the wait characteristics of a program or job may be used to slow down or speed up the collection. For example, while tracing the job, if the job goes into long waits during execution, those of ordinary skill in the art may appreciate that less collection of performance data is needed to determine the events of the job that are skipped. Thus, the sampling interval may be increased. On the other hand, if the job goes into short waiting periods, then the sampling interval may be decreased as more collections may be needed to determine the events of the job.

Those of ordinary skill in the art may further appreciate that other types of rules may be used consistent with the invention. In particular, those of ordinary skill in the art may appreciate, e.g. from the rules referenced hereinabove, that autonomically adjusting when the performance data is collected may generally be based upon whether a skipped event may be reconstructed. Therefore, other rules that may be implemented to autonomically adjust when the performance data is collected based upon whether the skipped events may be reconstructed may be consistent with the invention. As a result, the scope of the invention should not be limited to the rules discussed hereinabove.

Returning to block 66 in FIG. 3, once any rules are read from a file, control passes to block 68 to initiate a for loop including blocks 68-72. For each rule read from the file, the rule may be applied to sampled call stacks in block 70, and the sampling interval may be adjusted in block 72. After all the rules have been processed, control returns to routine 50 in FIG. 2.

Turning now to routine 74 in FIG. 4, autonomic adjustments may also be made based on performance metrics. First, the call stacks may be analyzed in block 76, for example, for a performance metric such as I/O utilization. Next, block 78 initiates a for loop including blocks 78-80. For each traced performance metric, the sampling interval may be adjusted in block 80.

In particular, an autonomic adjustment may be based upon a burst of an event, e.g., a short burst of a performance metric such as I/O utilization. Thus, if I/O writes are taking place in a large degree, then the collection of the call stack may be sped up, i.e., the sampling interval maybe be decreased, but if I/O writes are not taking place, then collection may be slowed down, i.e., the sampling interval may be increased.

Additionally, an autonomic adjustment may be based upon linking the sampling interval to a performance metric such as CPU utilization. For example, a CPU monitor may be used; thus, when CPU utilization increases, the collection may be sped up, i.e., sampling interval decreased. This could be based upon a trigger, or could be proportional to the CPU. Any trigger known to those of ordinary skill in the art may be used. Furthermore, limits may be applied to the collection of performance data to avoid overwhelming the CPU.

Those of ordinary skill in the art may appreciate that other methodologies may be used to rely on performance metrics for autonomic adjustment consistent with the invention. Those of ordinary skill in the art may appreciate, e.g. from the methodologies referenced hereinabove, that autonomically adjusting when the performance data is collected may generally be based upon whether a skipped event may be reconstructed. Thus, the scope of the invention should not be limited to the methodologies discussed hereinabove. Nonetheless, returning to block 80 in FIG. 4, the sampling interval may be adjusted, and after the loop ends, control may return to routine 50 in FIG. 2. Furthermore, those of ordinary skill in the art may appreciate that the sampling interval may be autonomically adjusted by one or both of routines 64 or 74 in some embodiments consistent with the invention.

Turning now to routine 82 in FIG. 5, another exemplary routine is configured for autonomically adjusting the collection of the call stack by monitoring a performance metric. Block 84 determines which trace is active. Next, a performance metric may be collected in block 86, e.g., from collected performance data during at least one previous sample of the call stack. If the performance metric is occurring more frequently in block 88, then the collection of the call stack may be sped up in block 90, i.e., decreasing the sampling interval between collections of the call stack, and the routine exits. In particular, a user and/or system may determine at what point a performance metric is occurring more frequently or significantly more frequently so as to speed up the collection of the call stack, and/or the frequency of the performance metric may be determined using conventional techniques. On the other hand, if the performance metric is not occurring more frequently, control returns back to block 84. Those of ordinary skill in the art may appreciate that autonomically adjusting when the performance data is collected may generally be based upon whether a skipped event may be reconstructed.

The following example illustrates the advantage of the illustrated embodiments. For instance, an SQL exception may be thrown during the execution of a program. Generally, when such an SQL exception is thrown, a developer may want to diagnose the cause of the exception. Using conventional techniques, the call stack may be periodically collected, e.g., collecting the call stack every ten seconds. However, upon collecting the call stack, there may or may not be enough performance data collected to assist in diagnosing the SQL exception. Generally, the conventional approach is ad hoc, i.e., hit or miss.

However, consistent with the invention, the call stack may be collected more frequently in situations where it is expected that the SQL exception will be thrown. Therefore, when a pattern indicative of when the SQL exception is thrown is detected in the call stack, the call stack may be collected more frequently before the next SQL exception is expected to be thrown. Thus, increasing the likelihood that the performance data needed to rectify the problem will be captured. Furthermore, those of ordinary skill in the art may appreciate that by autonomically reducing when the performance data is collected from the call stack, at other times the call stack may be collected as infrequently as possible to limit the impact and the amount of performance data.

Various additional modifications may be made to the illustrated embodiments without departing from the spirit and scope of the invention. Therefore, the invention lies in the claims hereinafter appended.

What is claimed is:

1. A method of collecting performance data in a computer, the method comprising:
(a) executing a trace; and
(b) while executing the trace, autonomically adjusting when performance data from a call stack is collected.

2. The method of claim 1, wherein autonomically adjusting when performance data is collected is based upon whether a skipped event may be reconstructed.

3. The method of claim 1, wherein autonomically adjusting when performance data is collected is based upon comparing the call stack and a previous call stack for at least one change.

4. The method of claim 1, wherein autonomically adjusting when performance data is collected is based upon comparing the call stack and a previous call stack for a change in at least one class, package, method, procedure, routine or inlined program code.

5. The method of claim 1, wherein autonomically adjusting when performance data is collected is based upon the presence of at least one pattern in the call stack.

6. The method of claim 1, wherein autonomically adjusting when performance data is collected is based upon a trigger.

7. The method of claim 1, wherein the trace is executed on a job, and wherein autonomically adjusting when performance data is collected is based upon a wait characteristic of the job.

8. The method of claim 1, wherein autonomically adjusting when performance data is collected is based upon a burst of an event.

9. The method of claim 1, wherein autonomically adjusting when performance data is collected is based upon information collected from previous collections of performance data.

10. The method of claim 1, wherein autonomically adjusting when performance data is collected is based upon CPU utilization.

11. The method of claim 1, wherein autonomically adjusting when performance data is collected includes changing a sampling interval, wherein the sampling interval is a period between a first collection and a second collection of performance data, the method further comprising collecting the call stack according to the sampling interval.

12. A method of collecting performance data in a computer, the method comprising:
(a) analyzing a call stack during a trace; and
(b) autonomically adjusting when performance data from a call stack is collected based upon the analysis.

13. The method of claim 12, wherein autonomically adjusting when performance data is collected includes changing a sampling interval, wherein the sampling interval is a period between a first collection and a second collection of performance data, the method further comprising collecting the call stack according to the sampling interval.

14. An apparatus, comprising:
at least one processor;
a memory, and
program code resident in the memory and configured to be executed by the at least one processor to collect performance data in a computer by executing a trace, and while executing the trace, autonomically adjusting when performance data from a call stack is collected.

15. The apparatus of claim 14, wherein the program code is configured to autonomically adjust when performance data is collected based upon whether a skipped event may be reconstructed.

16. The apparatus of claim 14, wherein the program code is configured to autonomically adjust when performance data is collected based upon comparing the call stack and a previous call stack for at least one change.

17. The apparatus of claim 14, wherein the program code is configured to autonomically adjust when performance data is collected based upon comparing the call stack and a previous call stack for a change in at least one class, package, method, procedure, routine or inlined program code.

18. The apparatus of claim 14, wherein the program code is configured to autonomically adjust when performance data is collected based upon the presence of at least one pattern in the call stack.

19. The apparatus of claim 14, wherein the program code is configured to autonomically adjust when performance data is collected based upon a trigger.

20. The apparatus of claim 14, wherein the trace is executed on a job, and wherein the program code is configured to autonomically adjust when performance data is collected based upon a wait characteristic of the job.

21. The apparatus of claim 14, wherein the program code is configured to autonomically adjust when performance data is collected based upon a burst of an event.

22. The apparatus of claim 14, wherein the program code is configured to autonomically adjust when performance data is collected based upon information collected from previous collections of performance data.

23. The apparatus of claim 14, wherein the program code is configured to autonomically adjust when performance data is collected based upon CPU utilization.

24. The apparatus of claim 14, wherein the program code is configured to autonomically adjust when performance data is collected includes changing a sampling interval, wherein the sampling interval is a period between a first collection and a second collection of performance data and wherein the program code is further configured to collect the call stack according to the sampling interval.

25. A program product, comprising:
program code configured to collect performance data in a computer by executing a trace, and while executing the trace, autonomically adjusting when performance data from a call stack is collected; and
a computer readable medium bearing the program code.
